(19) United States
(12) Patent Application Publication
(10) Pub. No.: US 2007/0029740 A1
(43) Pub. Date: Feb. 8, 2007

(54) Body for keeping a wafer, method of manufacturing the same and device using the same

(76) Inventors: Masuhiro Natsuhara, Itami-shi (JP); Katsuhiro Itakura, Itami-shi (JP); Tomoyuki Awazu, Itami-shi (JP); Hirohiko Nakata, Itami-shi (JP); Akira Mikumo, Itami-shi (JP)

Correspondence Address: MCDERMOTT WILL & EMERY LLP, 600 13TH STREET, N.W., WASHINGTON, DC, 20005-3096, US

(21) Appl. No.: 11/482,101

(22) Filed: Jul. 7, 2006

(30) Foreign Application Priority Data
Jul. 7, 2005 (JP) 2005-198964 (P)
Oct. 31, 2005 (JP) 2005-315551 (P)

(51) Int. Cl. B23B 31/30

(52) U.S. Cl. 279/3

(57) ABSTRACT

A wafer holding body for placing a semiconductor wafer, a method of manufacturing the same, and an device using the wafer holding body are provided, wherein a channel is formed in the wafer holding body.

This nonprovisional application is based on Japanese Patent Applications Nos. 2005-198964, and 2005-315551 filed with the Japan Patent Office on Jul. 7, 2005 and Oct. 31, 2005, respectively, the entire contents of which are hereby incorporated by reference.

### BACKGROUND OF THE INVENTION

1. Field of the Invention

The present invention relates to a wafer holding body for use in a wafer prober for inspecting the electric characteristics of a semiconductor wafer by placing a semiconductor wafer on a wafer-placing surface and pressing a probe card against the semiconductor wafer, a method of manufacturing the same, a heater unit for a wafer prober including the wafer holding body, and a wafer prober provided with the heater unit for a wafer prober.

Furthermore, the present invention relates to a wafer holding body for heating a resist applied on a semiconductor wafer, or depositing a film on a semiconductor wafer by CVD or any other method, or performing etching or ashing on a semiconductor wafer, a wafer-heating heater unit including the wafer holding body, and a semiconductor heating device provided with the wafer-heating heater unit.

2. Description of the Background Art

Conventionally, in a step of inspecting a semiconductor wafer, a heating treatment is performed on a semiconductor wafer to be processed. Here, a burn-in step is performed in which a semiconductor wafer is heated to a temperature higher than a normally used temperature to accelerate a defect in a semiconductor chip that is potentially defective for removal in order to prevent a defective after shipment.

In this burn-in step, before a semiconductor wafer having a circuit formed therein is cut into individual semiconductor chips, the electric characteristics of each semiconductor chip are determined while the semiconductor wafer is heated, thereby removing a defective. In this burn-in step, reduction of the process time is strongly requested in order to improve a throughput.

In such a burn-in step, a heater unit for heating a semiconductor wafer is used which includes a wafer holding body for holding a semiconductor wafer. The wafer holding body used in a conventional heater unit uses a flat plate-like metal plate so that the entire back surface of a semiconductor wafer should be brought into contact with a ground electrode.

In the burn-in step, a semiconductor wafer having a circuit formed therein is placed on a wafer-placing surface of the wafer holding body which is a metal plate in order to determine the electric characteristics of a semiconductor wafer. In determining the electric characteristics of a semiconductor chip, a determiner called a probe card including a number of probe pins for supplying power is pressed against a semiconductor wafer at a force of a few tens of kgf to a few hundreds of kgf. Therefore, if a wafer holding body is thin, the wafer holding body is deformed, possibly resulting in poor contact between the semiconductor wafer and a probe pin. Thus, for the purpose of keeping the rigidity of the wafer holding body, a thick metal plate of 15 mm or thicker has to be used as a wafer holding body, which requires long time to increase and decrease the temperature of a semiconductor wafer and thus hinders improvement of throughput.

Moreover, in the burn-in step, the electric characteristics are determined by feeding current to a semiconductor chip. With higher power of recent semiconductor chips, semiconductor chips generate much heat during determination of electric characteristics of semiconductor chips. In some cases, semiconductor chips may be failed due to the generated heat from itself. Therefore, semiconductor chips need to be cooled rapidly after determination of the electric characteristics. In addition, since semiconductor chips should be uniform in temperature during determination of the electric characteristics, copper (Cu) having a high thermal conductivity of 403 W/mK is used as a material of the metal plate forming a wafer holding body.

Then, Japanese Patent Laying-Open No. 2001-033484 (Patent Document 1) proposes a wafer holding body including a thin metal layer formed on a surface of a ceramics substrate, which is thin but highly rigid and less likely to be deformed, in place of a wafer holding body formed of a thick metal plate. In Patent Document 1, this wafer holding body does not cause poor contact between a semiconductor wafer and a probe pin because of high rigidity and allows the temperature of a semiconductor wafer to increase and decrease for a short time because of low heat capacity. In addition, an aluminium alloy, a stainless steel or the like may be used for a support base for a wafer holding body.

However, as disclosed in Patent Document 1, if only the outermost circumference of the wafer holding body is supported by the support base, the pressure of the probe card may cause the wafer holding body to be warped. Therefore, in addition to the support base, any other technique is necessary such as a number of pillars supporting the wafer holding body.

Furthermore, recently, with miniaturization in semiconductor processes, the load per unit area of a semiconductor chip in probing is increased and in addition, the precision in registration between a probe card and a wafer holding body is required. The wafer holding body usually repeats an operation of heating a semiconductor wafer at a prescribed temperature, moving to a prescribed position in probing, and pressing a probe card against the semiconductor wafer. Here, high precision is also required of a driving system for moving the wafer holding body to a prescribed position.

However, when a semiconductor wafer is heated to a prescribed temperature, for example, a temperature of 100-200° C., the heat is transferred to the driving system, causing thermal expansion of a metal member forming the driving system. This reduces the precision of the driving system. Furthermore, with the increased load in probing, rigidity of the wafer holding body itself on which a semiconductor wafer is placed is also demanded. Therefore, the wafer holding body is increased in size and thus increased in mass, which increased mass has adverse effect on the precision of the driving system. Furthermore, with the increased size of the wafer holding body, the time required to increase and decrease the temperature of a semiconductor wafer is extremely long, thereby reducing a throughput.

Moreover, in order to shorten the time required to increase and decrease the temperature of a semiconductor wafer to improve a throughput, a cooling mechanism is often provided to a wafer holding body. A conventional cooling mechanism, for example, provides air cooling as disclosed in Patent Document 1 or is provided with a metal-made cold plate immediately below the wafer holding body. However, in the case of the former, the cooling speed is slow due to air cooling. On the other hand, in the case of the latter, the cold plate is made of a metal and the pressure of the probe card is directly applied to this cold plate in probing, so that the cold plate is easily deformed.

Furthermore, in production of semiconductor chips, the heater unit used to heat semiconductor wafers and the like is used to heat and dry resist liquid applied on a semiconductor wafer, for example, in a lithography process.

In such production of semiconductor chips, cheaper products are sought by means of mass production by continuous operations. Therefore, a reduced cycle time is desired in a manufacturing device for semiconductor chips. In order to achieve a high throughput in one manufacturing device, not only a process time for processed targets during the temperature maintenance time but also a time required to change the temperature of the wafer holding body (the temperature rise time, the cooling time) with changed process conditions need to be reduced.

Therefore, as proposed in Japanese Patent Laying-Open No. 2004-014655 (Patent Document 2), a cooling block having a desired heat capacity is brought into abutment with the heated wafer holding body, so that the temperature of the wafer holding body and a semiconductor wafer placed on the wafer holding body can be decreased for a short time thereby shortening the time required for the step of heating a semiconductor wafer.

However, in the method disclosed in Patent Document 2, an interface exists between the wafer holding body and the cooling block, which causes contact resistance. Thus, the cooling speed cannot be increased more than a certain level.

### SUMMARY OF THE INVENTION

In view of the foregoing situations, an object of the present invention is to provide a wafer holding body capable of rapidly cooling a semiconductor wafer placed on the wafer holding body, a method of manufacturing the same, and a device using the wafer holding body.

The present invention provides a wafer holding body for placing a semiconductor wafer. The wafer holding body includes a channel formed therein.

Here, the wafer holding body in accordance with the present invention may have a coating member attached to a side opposite to a wafer-placing surface of the wafer holding body. The channel may be formed between the wafer-placing surface and the coating member.

The wafer holding body in accordance with the present invention may have a coating member attached to a side opposite to a wafer-placing surface of the wafer holding body. A part of the channel may be formed of a concave portion formed in a main body portion of the wafer holding body.

The wafer holding body in accordance with the present invention may have a coating member attached to a side opposite to a wafer-placing surface of the wafer holding body. A part of the channel may be formed of a concave portion formed in the coating member.

The wafer holding body in accordance with the present invention may have a tubular member attached to a side opposite to a wafer-placing surface of the wafer holding body. The channel may be a hollow portion of the tubular member.

The wafer holding body in accordance with the present invention may have a heating element on a side opposite to a wafer-placing surface of the wafer holding body. Here, the heating element may be provided on a wafer-placing face side of the wafer holding body or may be provided on a side opposite to a side at which the wafer-placing surface of the wafer holding body exists, as viewed from the channel.

The wafer holding body in accordance with the present invention may have a coating member attached to a side opposite to the wafer-placing surface of the wafer holding body. The heating element may be provided on a surface of the coating member.

The present invention also provides a method of manufacturing a wafer holding body having a channel formed in a main body portion of the wafer holding body. The method includes the steps of embedding a core in a molded body before baking of the main body portion of the wafer holding body; and baking the molded body having the core embedded therein to cause the core to disappear thereby forming a channel.

The present invention also provides a method of manufacturing a wafer holding body having a coating member attached to a side opposite to a wafer-placing surface of the wafer holding body and having a channel formed therein. The channel is formed in the wafer holding body by joining a main body portion of the wafer holding body and the coating member with each other. Here, the main body portion of the wafer holding body and the coating member can be joined with each other by a solder material, a joining material containing an inorganic material, or a mechanical method. Screwing can be used as the mechanical method.

The present invention also provides a method of manufacturing a wafer holding body having a coating member attached to a side opposite to a wafer-placing surface of the wafer holding body and having a channel formed therein. The channel is formed by joining a main body portion of the wafer holding body and a tubular member with each other. Here, the main body portion of the wafer holding body and the tubular member can be joined with each other by a solder material, a joining material containing an inorganic material, or a mechanical method. Screwing can be used as the mechanical method.

The present invention also provides a heater unit for a wafer prober, including the wafer holding body as described above.

The present invention also provides a wafer prober including the heater unit for a wafer prober as described above.

The present invention also provides a wafer-heating heater unit including the wafer holding body as described above.

The present invention also provides a semiconductor heating device including the wafer-heating heater unit as described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross sectional view of an exemplary wafer holding body in accordance with the present invention.

FIG. 2 is a schematic cross sectional view of another example of a wafer holding body in accordance with the present invention.

FIG. 3 is a schematic cross sectional view of another example of a wafer holding body in accordance with the present invention.

FIG. 4 is a schematic cross sectional view of another example of a wafer holding body in accordance with the present invention.

FIG. 5 is a schematic cross sectional view of another example of a wafer holding body in accordance with the present invention.

FIG. 6 is a schematic cross sectional view of an exemplary heater used in the present invention.

FIG. 7 is a schematic plan view of an exemplary support body used in the present invention.

FIG. 8 is a schematic plan view of another example of a support body used in the present invention.

FIG. 9 is a schematic plan view of another example of a support body used in the present invention.

FIG. 10 is a schematic cross sectional view of another example of a wafer holding body in accordance with the present invention.

FIG. 11 is a schematic enlarged cross sectional view of a part of the wafer holding body shown in FIG. 10.

FIG. 12 is a schematic cross sectional view showing an exemplary stack of individual members forming a molded body before baking, of a main body portion of a wafer holding body used in the present invention.

FIG. 13 is a schematic cross sectional view showing an exemplary stack of individual members forming a molded body before baking, of a main body portion of a wafer holding body used in the present invention.

FIG. 14 is a schematic cross sectional view showing an exemplary stack of individual members forming a molded body before baking, of a main body portion of a wafer holding body.

FIG. 15 is a schematic structural view of an exemplary heater unit using the wafer holding body in accordance with the present invention.

### DESCRIPTION OF THE PREFERRED EMBODIMENTS

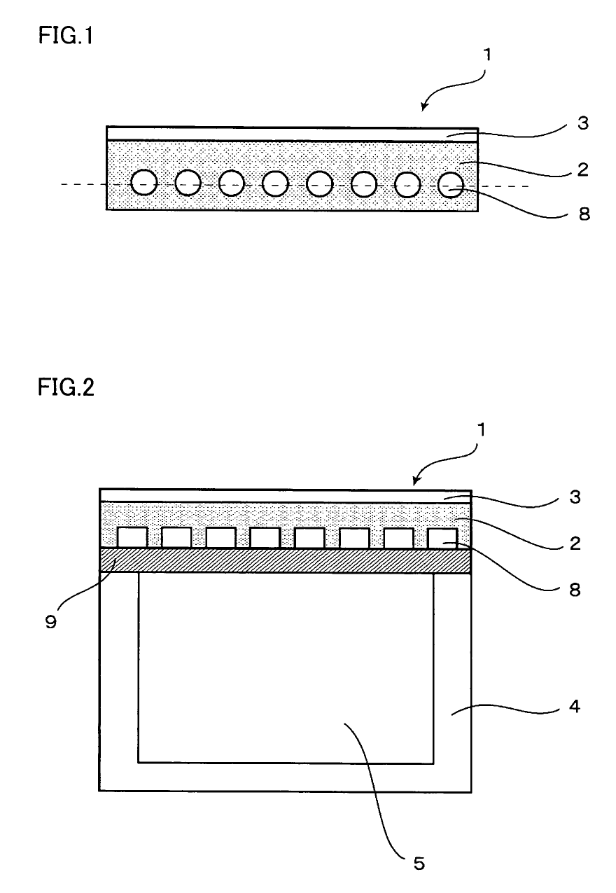

FIG. 1 shows a schematic cross sectional view of an exemplary wafer holding body in accordance with the present invention. Here, a wafer holding body 1 in accordance with the present invention has a chuck top 2 as a main body of the wafer holding body, a chuck top conductive layer 3 formed on chuck top 2, and a channel 8 formed in chuck top 2. In wafer holding body 1 in this manner in accordance with the present invention, chuck top 2 can rapidly be cooled by feeding a fluid into channel 8, so that a semiconductor wafer placed on a wafer-placing surface of wafer holding body 1 (here, the surface of chuck top conductive layer 3 opposite to the side in contact with chuck top 2) can be cooled rapidly. Because of such a configuration, the fluid flowing in channel 8 efficiently contributes to cooling of chuck top 2 thereby significantly improving the speed of cooling a semiconductor wafer.

As a material of chuck top 2, for example, a metal such as tungsten or molybdenum or ceramics such as aluminium nitride, silicon nitride, alumina, silicon carbide, or mullite.

Here, when chuck top 2 is formed of a metal such as tungsten or molybdenum, channel 8 is formed by preparing a plurality of molded bodies made of metal powder and having a shape divided in the dotted line in FIG. 1 such that channel 8 is divided, and mating and baking these molded bodies. Alternatively, channel 8 may be formed by fabricating a plurality of members, each formed by partially removing a metal plate made of the above-noted metal by machining in such a shape that channel 8 is divided, and then joining these members by a solder material.

On the other hand, when chuck top 2 is formed of ceramics such as aluminium nitride, silicon nitride, alumina, silicon carbide, or mullite, channel 8 may be formed by stacking a green sheet having a portion removed in a concave shape to serve as channel 8 and a flat plate-like green sheet not having a portion removed in a concave shape, and thereafter baking these sheets. In this case, channel 8 can be formed in chuck top 2 by embedding a core made of paraffin or the like into the molded body before baking of chuck top 2 and baking the molded body embedded with the core to cause the core to disappear. Alternatively, in this case, channel 8 may be formed by fabricating a plurality of members, each formed by partially removing a ceramic plate made of the above-noted ceramics by machining in such a shape that channel 8 is divided, and then joining these members by a solder material.

Furthermore, when chuck top 2 is formed of a composite of metal and ceramics, channel 8 may be formed using a solder material similarly as described above.

In this manner, with any material or any method used to form channel 8 in chuck top 2, chuck top 2 superior in cooling efficiency can be formed because of channel 8 formed inside chuck top 2.

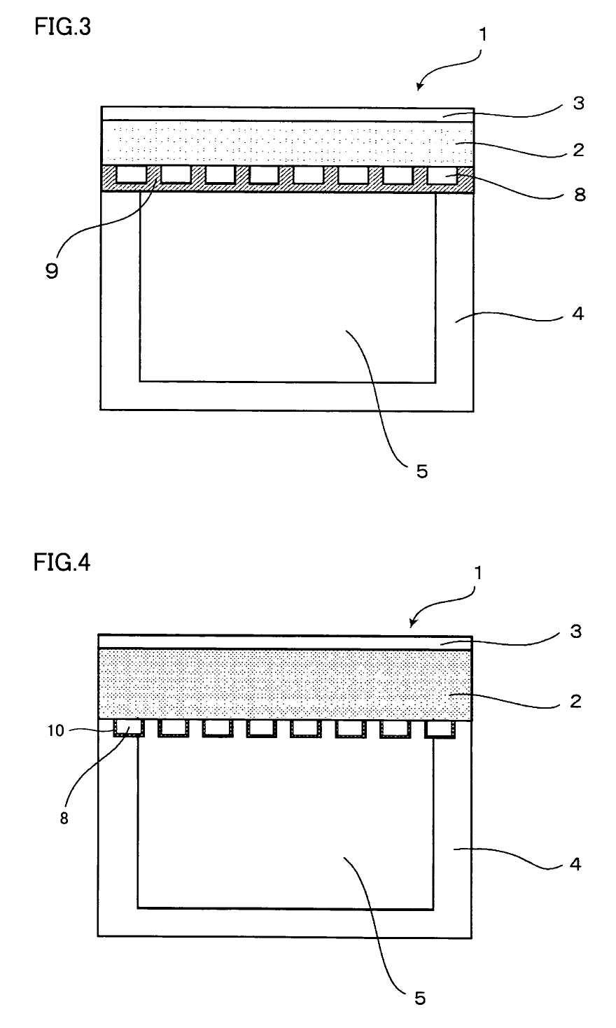

Here, as a method of forming channel 8 in chuck top 2, for example, the following method can also be used. First, as shown in FIG. 2 or FIG. 3, a coating member 9 is attached to the surface opposite to the wafer-placing surface of chuck top 2. Then, as shown in FIG. 2 or FIG. 3, channel 8 is formed in chuck top 2 or coating member 9, which are then integrated, resulting in channel 8. Also in this case, as a material of chuck top 2, metal, ceramics, a composite of metal and ceramics, or the like can be used. Here, as a method of joining chuck top 2 and coating member 9, a solder material or a joining material is preferably used, if the fluid fed into channel 8 is liquid. In this manner, leakage of liquid as a fluid is likely to be minimized.

The solder material for use in the present invention is not specifically limited. For example, a commercially available, active metal solder material or so-called silver solder may be used. Furthermore, the joining material for use in the present invention may include slurry including an inorganic material having a component similar to chuck top 2 and coating member 9, if both chuck top 2 and coating member 9 are made of ceramics. This slurry is applied on the joining surfaces of chuck top 2 and coating member 9 to join them to each other. Further, when the highest temperature for use in the wafer holding body of the present invention is about 200° C., a resin adhesive including an organic component may be used to join chuck top 2 and coating member 9.

In the present invention, as a method of joining chuck top 2 and coating member 9, an O-ring may be interposed between chuck top 2 and coating member 9 so that chuck top 2 and coating member 9 are joined by a mechanical method, using a screw or the like. Here, although chuck top 2 and coating member 9 may be joined mechanically by screwing or the like, if the fluid fed into channel 8 is gas, the hermetic joining method using a solder material or a joining material can increase the cooling efficiency and thus more preferable.

It is noted that in the method shown in FIG. 2 or FIG. 3, different materials may be used for chuck top 2 and coating member 9. In particular when chuck top 2 and coating member 9 are joined by a mechanical method such as screwing, the difference in thermal expansion coefficient of the materials between chuck top 2 and coating member 9 does not much matter.

FIG. 4 shows a schematic cross sectional view of another example of a wafer holding body in accordance with the present invention. Here, wafer holding body 1 in accordance with the present invention is characterized by a tubular member 10 attached to chuck top 2 on the side opposite to the wafer-placing surface of wafer holding body 1. The hollow portion of this tubular member 10 serves as channel 8.

Here, the method of joining chuck top 2 and tubular member 10 is not specifically limited. For example, in a manner similar as described above, a solder material, a joining material containing an inorganic material, or a mechanical method may be used. In order to improve the cooling speed of chuck top 2, a larger contact area between chuck top 2 and tubular member 10 is preferable. Therefore, the cross sectional shape of tubular member 10 may be circular but may be polygonal such as rectangular or triangular so that the contact area between chuck top 2 and tubular member 10 can be increased, thereby further improving the speed of cooling a semiconductor wafer.

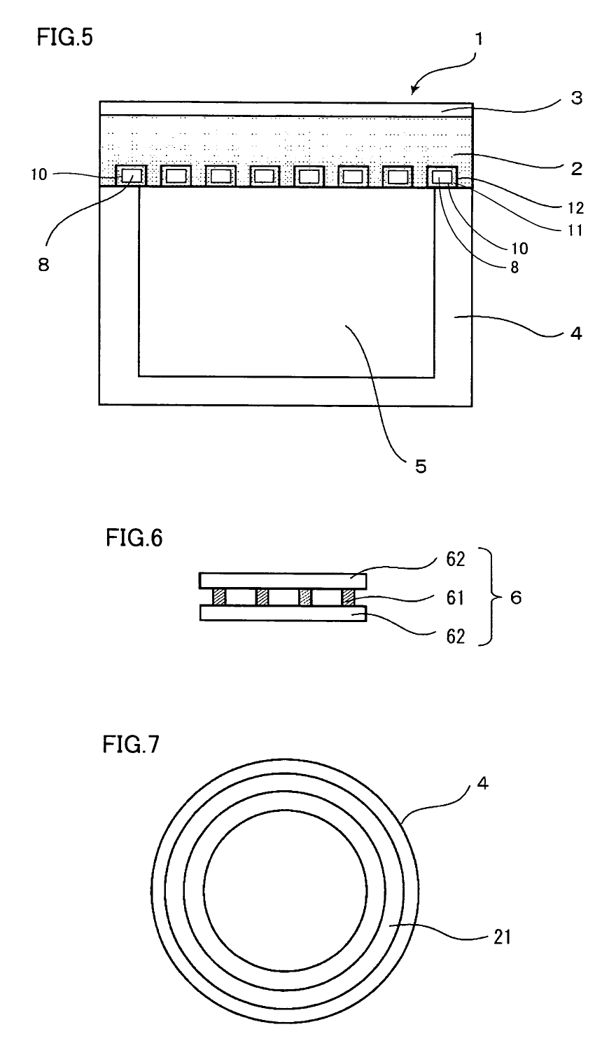

FIG. 5 shows a schematic cross sectional view of another example of a wafer holding body in accordance with the present invention. Here, wafer holding body 1 in accordance with the present invention is characterized by tubular member 10 for cooling which is embedded in a spot-faced portion 12 formed in chuck top 2. In this manner, tubular member 10 for cooling is embedded in spot-faced portion 12 of chuck top 2 thereby improving the speed of cooling a semiconductor wafer.

Here, if the method of joining chuck top 2 and tubular member 10 uses a solder material or a joining material containing an inorganic material, the cooling speed tends to be relatively high since the gap between chuck top 2 and tubular member 10 can be reduced. However, in the mechanical joining method such as screwing, the thermal resistance between chuck top 2 and tubular member 10 is increased as compared with the joining method using a solder material or the like. Then, the thermal resistance between chuck top 2 and tubular member 10 is reduced by inserting an interposing layer 11 between chuck top 2 and tubular member 10, thereby improving the cooling speed.

Here, interposing layer 11 is not specifically limited as long as it closes the gap between chuck top 2 and tubular member 10. For example, silicone resin, epoxy resin, or any other heat-resistant resin may be used. In addition, a filler made of ceramics or metal may be introduced to interposing layer 11 so that the thermal conductivity of interposing layer 11 is improved thereby improving the thermal efficiency. Here, the filler introduced to interposing layer 11 is not specifically limited as long as the thermal conductivity is higher than the base material of interposing layer 11. For example, powder of boron nitride, aluminium nitride, alumina or the like having thermal conductivity higher than resin can be used.

Furthermore, wafer holding body 1 in accordance with the present invention may include a support body 4 supporting chuck top 2 and may have a cavity 5 between chuck top 2 and support body 4, as shown in FIG. 5. This cavity 5 can increase the heat-insulation effect. The shape of cavity 5 is not specifically limited, for example, such that the amount of heat or cool air produced in chuck top 2 that is transferred to support body 4 can be minimized as much as possible. Support body 4 is preferably shaped like a cylinder with a base so that the contact area between chuck top 2 and support body 4 can be reduced and cavity 5 can easily be formed. Cavity 5 formed in this manner includes air in the most part between chuck top 2 and support body 4 thereby providing an efficient heat insulating structure.

In addition, the wafer holding body in accordance with the present invention preferably has a heating element such as a resistance heating element. This is because in probing of semiconductor wafers in recent years, semiconductor wafers are often heated to a temperature of 100° C.-200° C. Therefore, when a heating element is caused to generate heat in wafer holding body 1 having a configuration, for example, shown in FIG. 5, heat is transferred to a driving system provided under support body 4 if heat from the heating element installed at chuck top 2 is not prevented from being transferred to support body 4. Then, the difference in thermal expansion between the members of the driving system causes deviations in precision, which may cause significant reduction in flatness and parallelism of the wafer-placing surface of wafer holding body 1. However, since wafer holding body 1 having a configuration shown in FIG. 5 has a heat insulating structure because of cavity 5, the flatness and parallelism of the wafer-placing surface of wafer holding body 1 are less likely to be reduced. In addition, wafer holding body 1 having a configuration shown in FIG. 5 uses hollow support body 4 having cavity 5, so that weight reduction can be achieved as compared with when a solid, cylinder-shaped support is used.

FIG. 6 shows a schematic cross sectional view of an exemplary heater for use in the present invention. Here, a heater 6 is configured such that a resistance heating element 61 is sandwiched between insulators 62. For example, a metal foil made of a metal such as nickel, stainless steel, silver, tungsten, molybdenum, chrome, or an alloy including at least two kinds thereof can be used as resistance heating element 61.

Specifically, stainless steel or nichrome is preferably used as a metal used for resistance heating element 61. When processed into the shape of a heating element, stainless steel and nichrome are likely to form a resistance heating element circuit pattern relatively precisely by etching or any other technique. In addition, stainless steel and nichrome are cheap and acid-resistant, so that they are likely to be resistant to prolonged use even when used at a high temperature.

Moreover, insulator 62 is not specifically limited as long as it is heat-resistant. For example, mica, silicone resin, epoxy resin, phenol resin, or the like may be used.

Furthermore, as shown in FIG. 6, when heater 6 is configured such that resistance heating element 61 is sandwiched between insulators 62 made of insulating resin, a filler can be dispersed in the insulating resin that forms insulator 62 in order to smoothly transfer the heat generated in resistance heating element 61 to chuck top 2. This filler serves to increase the heat conduction of the insulating resin such as silicone resin. A material used for this filler is not specifically limited as long as it is not reactive with the insulating resin that forms insulator 62. For example, boron nitride, aluminium nitride, alumina, or silica may be used. It is noted that heater 6 can be fixed, for example, to the portion at which heater 6 is provided (for example, the surface of coating member 9 or the like), by a mechanical method such as screwing.

The heating element such as resistance heating element 61 may be embedded in chuck top 2. Here, as a method of embedding the heating element in chuck top 2, for example, if chuck top 2 is formed of a ceramics substrate, a metal paste such as tungsten or molybdenum is, for example, screen-printed on a ceramics substrate, and a ceramics substrate on which a metal paste is printed and a ceramics substrate on which a metal paste is not printed are stacked and joined to each other.

Alternatively, the heating element such as resistance heating element 61 may be provided on the surface opposite to the wafer-placing surface of chuck top 2 by screen-printing or any other method. In this case, the material of resistance heating element 61 may be a screen-printable conductor including silver, palladium, platinum, tungsten, or molybdenum.

Furthermore, in the foregoing description, wafer holding body 1 in accordance with the present invention is mainly used for a wafer prober. However, wafer holding body 1 of the present invention may be used for a semiconductor heating device. When wafer holding body 1 in accordance with the present invention is used for a semiconductor heating device, a semiconductor wafer may be heated while being placed spaced from the wafer-placing surface of wafer holding body 1. For example, a semiconductor wafer can be placed spaced 100 μm from wafer holding body 1 by forming three or more spot-faced holes each having a diameter of 1.1 mm and a depth of 0.9 mm at the wafer-placing surface, and installing a ceramics ball of a diameter of 1 mm in each of the spot-faced hole. In this manner, a semiconductor wafer is placed spaced from wafer holding body 1, thereby improving the thermal uniformity of a semiconductor wafer.

Preferably, Young's modulus of support body 4 shown in FIG. 5 is 200 GPa or more. If Young's modulus of support body 4 is less than 200 GPa, the thickness of the base portion of support body 4 cannot be reduced and thus the volume of cavity 5 cannot be secured enough. Therefore, the heat-insulation effect by cavity 5 cannot be achieved enough. In addition, if Young's modulus of support body 4 is less than 200 GPa, the space in which a cooling module described later is provided cannot be reserved. More preferably, Young's modulus of support body 4 is 300 GPa or more. In particular, when a material having Young's modulus of 300 GPa or more is used for support body 4, deformation of support body 4 is considerably reduced, so that further miniaturization and weight reduction of support body 4 are preferably achieved.

In addition, a cooling module may be provided in cavity 5 of support body 4. Here, the cooling module may be movable according to the use and purpose or may be fixed to chuck top 2. Alternatively, chuck top 2 and the cooling module may be integrated. In this case, a chuck top anti-deformation substrate for preventing deformation of chuck top 2 may be provided on that portion of chuck top 2 which is opposite to the wafer-placing surface. Alternatively, an anti-deformation substrate having a function of a chuck top may be provided on a cooling module.

Preferably, the thermal conductivity of support body 4 is 40 W/mK or less. If the thermal conductivity of support body 4 exceeds 40 W/mK, the heat applied to chuck top 2 is easily transferred to support body 4, which may affect the precision of the driving system.

Recently, it is requested that a semiconductor wafer should be heated at a high temperature of 150° C. in probing. Therefore, in order to prevent heat transfer to the driving system, the thermal conductivity of support body 4 is more preferably 10 W/mK or less. More preferably, the thermal conductivity of support body 4 is 5 W/mK or less. When the thermal conductivity of support body 4 is 5 W/mK or less, the amount of heat transmission from support body 4 to the driving system tends to be significantly reduced.

As a material of support body 4 to satisfy the thermal conductivity condition as described above, mullite, alumina, or a composite of mullite and alumina (mullite-alumina composite) is preferably used. Mullite is preferable in that the thermal conductivity is small and the heat-insulation effect is high. Alumina is preferable in that Young's modulus is large and the rigidity is high. Mullite-alumina composite is generally preferable in that the thermal conductivity is smaller than that of alumina and Young's modulus is larger than that of mullite.

Preferably, the thickness of the cylindrical portion of support body 4 shaped like a cylinder with a base is 20 mm or less. If the thickness of the cylindrical portion of support body 4 exceeds 20 mm, the amount of heat transmission from chuck top 2 to support body 4 may be increased. However, if the thickness is less than 1 mm, the pressure of the pressed probe card in probing of a semiconductor wafer causes the cylindrical portion of support body 4 to be deformed or damaged. In view of the foregoing, more preferably, the thickness of the cylindrical portion of support body 4 shaped like a cylinder with a base is at least 10 mm and at most 15 mm. In addition, the thickness of that portion of cylindrical portion of support body 4 which is in contact with chuck top 2 is preferably at least 2 mm and at most 5 mm. When this thickness is at least 2 mm and at most 5 mm, the balance of support body 4 between strength and heat insulation is likely to be improved.

Preferably, the height of the cylindrical portion of support body 4 (the height excluding the thickness of the base portion of support body 4) is 10 mm or more. If the height of the cylindrical portion of support body 4 is less than 10 mm, the pressure from the probe card is applied to chuck top 2 and additionally transferred to support body 4 during probing. Therefore, the base portion of support body 4 may be distorted thereby possibly deteriorating the flatness of chuck top conductive layer 3.

Preferably, the thickness of the base portion of support body 4 is 10 mm or more. If the thickness of the base portion of support body 4 is less than 10 mm, the pressure from the probe card is applied to chuck top 2 and additionally transferred to support body 4 in probing. Therefore, the base portion of support body 4 may be distorted thereby possibly deteriorating the flatness of chuck top conductive layer 3.

Preferably, the thickness of the base portion of support body 4 is at least 10 mm and at most 35 mm. If the thickness of the base portion of support body 4 is less than 10 mm, in addition to the aforementioned problem, heat of chuck top 2 is easily transferred to the base portion of support body 4, which may cause support body 4 to be warped due to thermal expansion thereby possibly deteriorating the flatness and parallelism of the wafer-placing surface. On the other hand, if the thickness of the base portion of support body 4 is 35 mm or less, suitably, wafer holding body 1 of the present invention can be miniaturized.

Alternatively, the cylindrical portion and the base portion of support body 4 may not be integrated but may be separated. In this case, an interface is formed between the separated cylindrical portion and base portion. This interface serves as a heat resistance layer, so that the heat transferred from chuck top 2 to support body 4 is blocked at this interface. Accordingly, the temperature of the base portion of support body 4 is less likely to be increased.

Preferably, a heat insulating structure is provided at the supporting surface of support body 4 which supports chuck top 2. Here, the heat insulating structure may be fabricated, for example, by partially notching the supporting surface of support body 4 to form a groove. This groove reduces the contact area between chuck top 2 and support body 4, resulting in a heat insulating structure.

Preferably, when a groove is formed at the supporting surface of support body 4, Young's modulus of chuck top 2 is 250 GPa or more. In probing, the pressure of the probe card is applied to chuck top 2, and therefore the amount of deformation of chuck top 2 made of a material having small Young's modulus is increased if a groove is present in the supporting surface of support body 4. Then, the increased amount of deformation of chuck top 2 may lead to a damage to a semiconductor wafer and a damage to chuck top 2

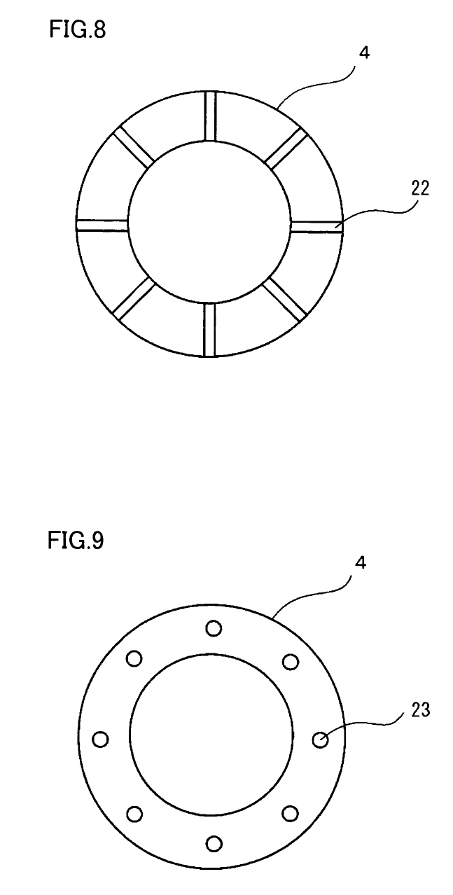

Furthermore, the groove formed at the supporting surface of support body 4 may include, for example, a concentrically-arranged groove 21 as shown in FIG. 7, a radially-arranged groove 22 as shown in FIG. 8, a groove provided with a number of protrusions, a groove shaped like a rectangle, or the like. The shape of the groove is not specifically limited but preferably symmetric. If the shape of the groove is not symmetric, the pressure applied to chuck top 2 cannot be distributed uniformly, which may have an effect of deformation or damage of chuck top 2.

In addition, as the heat insulating structure provided at the supporting surface of support body 4 which supports chuck top 2, for example, as shown in FIG. 9, a plurality of pillar-like members 23 can be installed on the supporting surface of support body 4. Here, pillar-like members 23 are preferably arranged evenly in a concentric manner or any manner similar thereto. The number of pillar-like members 23 is eight or more. Recently, the size of a semiconductor wafer is increased such as 8 to 12 inches. Therefore, if pillar-like members 23 are less than eight, the distance between pillar-like members 23 is increased so that chuck top 2 may be bent between pillar-like members 23 when a probe pin of a probe card is pressed against a semiconductor wafer placed on chuck top 2. In addition, since two interfaces are formed, that is, the interface between chuck top 2 and pillar-like member 23 and the interface between pillar-like member 23 and support body 4, these interfaces serve as thermal-resistance layers. Thus, the thermal-resistance layer can be doubled, so that the transmission of heat generated at chuck top 2 to support body 4 can effectively be insulated.

Furthermore, the shape of pillar-like member 23 is not specifically limited. For example, it may be shaped like a cylinder, a triangular prism, a quadrangular prism, a pipe, or any other polygon. Pillar-like member 23 is inserted between chuck top 2 and support body 4 in this way, so that heat transmission from chuck top 2 to support body 4 can effectively be prevented.

Here, the material used for pillar-like member 23 includes, for example, silicon nitride, mullite, a mullite-alumina composite, steatite, cordierite, stainless steel, glass, heat resistant resin such as polyimide, epoxy, or phenol, or a composite thereof.

Preferably, the material of pillar-like member 23 has a thermal conductivity of 30 W/mK or less. If the thermal conductivity of the material of pillar-like member 23 exceeds 30 W/mK, the effect of preventing heat transmission from chuck top 2 to support body 4 may be reduced.

Furthermore, when support body 4 is in contact with chuck top 2, at least one of the contact surface of support body 4 and the contact surface of chuck top 2 at their contact portion preferably has the surface roughness Ra of 0.1 μm or more. If the support body is in contact with chuck top 2 with pillar-like member 23 interposed therebetween, at least one of the contact surface of support body 4, the contact surface of pillar-like member 23, and the contact surface of chuck top 2 at their contact portions preferably has the surface roughness Ra of 0.1 μm or more. If the surface roughness Ra is less than 0.1 μm, the contact area of the above-noted contact portion increases and in addition, the cavity at the contact portion is relatively reduced. Therefore, the amount of heat transmission tends to increase as compared with when the surface roughness Ra is 0.1 μm or more.

It is noted that although the upper limit of the above-noted surface roughness is not specifically defined, it may cost much to treat the surface with the surface roughness Ra of 5 μm or more. The method of providing the surface roughness Ra of 0.1 μm or more includes, for example, polishing or sandblasting. In this case, the polishing conditions or sandblasting conditions need to be set properly to control the above-noted surface roughness Ra at 0.1 μm or more. It is noted that the surface roughness Ra refers to arithmetic mean roughness Ra defined by JIS B 0601.

Preferably, the surface roughness Ra of the base portion of support body 4 is 0.1 μm or more. As described above, the coarse surface roughness of the base portion of support body 4 can decrease the amount of heat transmission to the driving system.

When the base portion and the cylindrical portion of support body 4 can be separated from each other, at least one of the surface roughness Ra of the contact surface of the base portion and the surface roughness Ra of the contact surface of the cylindrical portion at the contact portion between the base portion and the cylindrical portion of support body 4 is preferably 0.1 μm or more. If the surface roughness Ra is less than 0.1 μm, the effect of blocking heat from the cylindrical portion to the base portion may be reduced.

As described above, a contact portion is formed between members that constitute the wafer holding body, and the surface roughness Ra of the contact surface that forms the contact portion thereof is 0.1 μm or more, so that the amount of heat transmission to the base portion of support body 4 can be reduced, resulting in a reduced amount of power supply to the heating element.

Preferably, the perpendicularity of the outer circumferential portion of the cylindrical portion of support body 4 with respect to the contact surface between the support body 4 and chuck top 2, or of the outer circumferential portion of the cylindrical portion of support body 4 with respect to the contact surface between pillar-like member 23 and chuck top 2 is 10 mm or less in terms of measurement length 100 mm. For example, if the perpendicularity exceeds 10 mm, the cylindrical portion of support body 4 is likely to be deformed when the pressure applied from chuck top 2 is applied to the cylindrical portion of support body 4.

Preferably, the area of the contact surface between support body 4 and chuck top 2 is 10% or less of the entire area where support body 4 and chuck top 2 are faced to each other. Preferably, at least part of the periphery of the portion where support body 4 is in contact with chuck top 2 is within 5 mm from the outer circumference of chuck top 2.

Preferably, a metal layer is formed on the surface of support body 4. Since an electric field or electromagnetic wave produced from the heating element for heating chuck top 2, the driving system or peripheral equipment causes an effect as noise during probing, the formation of a metal layer on the surface of support body 4 may block this electromagnetic wave. It is noted that a method of forming a metal layer is not specifically limited. For example, a conductive paste of metal powder such as silver, gold, nickel, or copper with addition of glass frit may be applied by a brush and baked.

Alternatively, the metal layer may be formed by thermally spraying a metal such as aluminium or nickel. Alternatively, the metal layer may be formed by plating a metal on the surface of support body 4. Alternatively, the metal layer may be formed by combining these methods. More specifically, the metal layer may be formed by baking a conductive paste and thereafter plating a metal such as nickel, or the metal layer may be formed by thermally spraying a metal and thereafter plating a metal. Among others, the metal layer is preferably formed by plating or thermally spraying a metal. Since plating provides a high adhesive strength, the reliability of the metal layer may be high. On the other hand, thermally spraying may allow the metal layer to be formed at relatively low costs.

Alternatively, the metal layer may be formed by providing a conductor at at least part of the surface of the support body. Here, a material of the conductor is not specifically limited. For example, stainless steel, nickel, aluminium, or the like may be used.

Furthermore, a conductor may be installed by attaching a ring-shaped conductor to the side surface of the support body. For example, a conductor may be installed by forming a metal foil in a ring shape having a size larger than the diameter of the support body and attaching the foil to the side surface of the support body. In addition, a metal foil or a metal plate may be attached to the bottom surface (the back surface of the base portion) of support body 4 and connected to the metal foil attached to the side surface of support body 4, thereby increasing the effect of blocking an electromagnetic wave (guard effect). Furthermore, cavity 5 inside support body 4 may be used, where a metal foil or a metal plate may be attached inside cavity 5 shaped like a cylinder with a base and connected to the metal foils attached to the side surface and the bottom surface of support body 4, thereby further increasing the guard effect. By employing such a method, the guard effect can be achieved relatively inexpensively as compared with the application of plating or a conductive paste. A method of fixing a metal foil or metal plate to support body 4 is not specifically limited. For example, a metal foil or metal plate may be attached to support body 4 using a metal screw. Preferably, the metal foils or metal plates at the bottom surface and the side surface of support body 4 may be integrated.

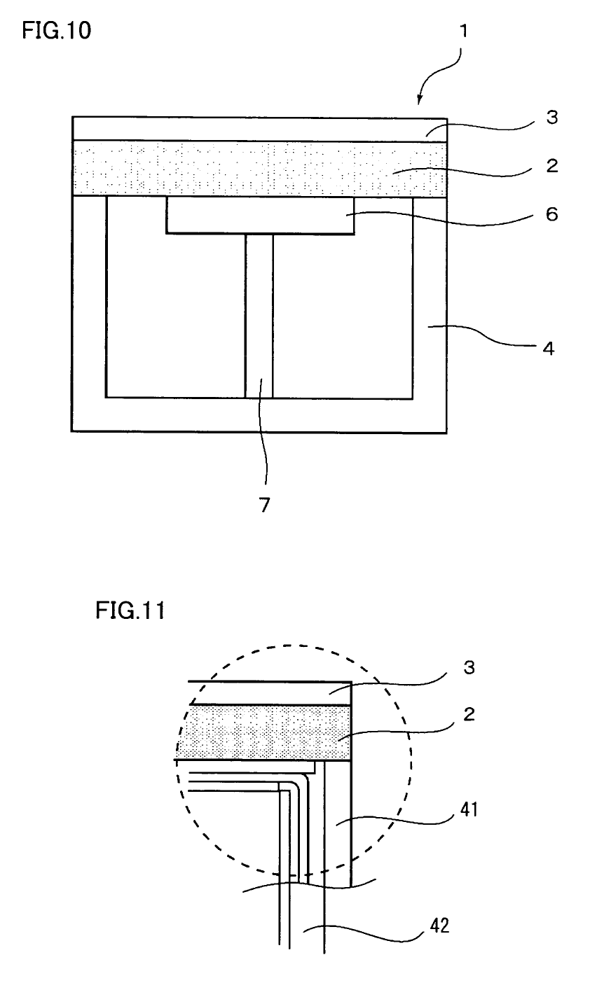

FIG. 10 shows a schematic cross sectional view of another example of a wafer holding body in accordance with the present invention. Here, wafer holding body 1 in accordance with the present invention is characterized in that a support rod 7 is provided in the vicinity of the central portion of cavity 5 inside support body 4 and a heater 6 is provided at the tip end portion of support rod 7.

Because of such a configuration, when a probe card is pressed against chuck top 2 during probing, support rod 7 prevents deformation of chuck top 2.

The material of support rod 7 is preferably the same material as support body 4. Both support body 4 and support rod 7 thermally expand because they receive heat from heater 6 that heats chuck top 2. Here, if the material of support body 4 is different from that of support rod 7, the difference of the thermal expansion coefficient causes unevenness between support body 4 and support body 7, so that chuck top 2 is easily be deformed.

The size of support rod 7 is not specifically limited. However, the cross sectional area of support rod 7 is preferably 0.1 cm² or more. If the cross sectional area of support rod 7 is less than 0.1 cm², the supporting effect is not enough and support rod 7 is likely to be deformed. Furthermore, the cross sectional area of support rod 7 is preferably 100 cm² or less. If the cross sectional area of support rod 7 exceeds 100 cm², the heat from chuck top 2 is easily transferred to the base portion of support body 4, so that the temperature of the base portion of support body 4 is more likely to be increased.

The shape of support rod 7 is not specifically limited. For example, a cylindrical shape, a triangular prism shape, a quadrangular prism shape, a pipe shape, or the like may be employed. The method of fixing support rod 7 to support body 4 is also not specifically limited and includes soldering using an active metal solder material, glass sealing, screwing, or the like. Among these, screwing is particularly preferable. The screwing facilitates attachment/removal of support rod 7 to/from support body 4 and in addition eliminates the need for thermal treatment in fixing, thereby preventing thermal deformation of support body 4 and support rod 7.

In addition, an electromagnetic shielding electrode layer is also formed between heater 6 and chuck top 2 to block (shield) an electromagnetic wave. This electromagnetic shielding electrode layer serves to block noise caused by an electromagnetic wave or an electric field produced in heater 6 or the like, which may affect probing of a semiconductor wafer. This noise does not have significant impact on the determination of normal electric characteristics of a semiconductor wafer but has a considerable impact on the determination of high-frequency characteristics of a semiconductor wafer. This electromagnetic shielding electrode layer may be formed, for example, by inserting a metal foil between heater 6 and chuck top 2, where chuck top 2 and heater 6 each should be insulated. The material of the metal foil for use in the electromagnetic shielding electrode layer is not specifically limited. Since the temperature of heater 6 becomes approximately 200° C., stainless steel, nickel, aluminium, or the like is preferable as the material of the metal foil.

It is noted that a capacitor is formed in an electrical circuit between chuck top 2 and chuck top conductive layer 3 if chuck top 2 is an insulator, or between chuck top 2 and electromagnetic shielding electrode layer if chuck top 2 is a conductor. This capacitor may have an effect as noise during probing of a semiconductor wafer. Therefore, the formation of an insulating layer between the electromagnetic shielding electrode layer and chuck top 2 can reduce the effect of noise.

In addition, a guard electrode layer is preferably provided between chuck top 2 and the electromagnetic shielding electrode layer with an insulating layer interposed therebetween. The guard electrode layer is connected to the metal layer formed on support body 4, so that noise that affects the determination of high-frequency characteristics of a semiconductor wafer may further be reduced.

More specifically, in the present invention, support body 4 containing heater 6 therein is entirely covered with a conductor, so that noise that may have an effect on the determination of high-frequency characteristics of a semiconductor wafer can be reduced. In addition, the guard electrode layer can be connected to the metal layer provided on support body 4, thereby further reducing the effect of noise.

Here, the resistance value of the insulating layer between heater 6 and the electromagnetic shielding electrode layer, between the electromagnetic shielding electrode layer and the guard electrode layer, between the guard electrode layer and chuck top 2 is preferably 10⁷Ω or more. If the resistance value is less than 10⁷Ω, minute current flows toward chuck top conductive layer 3 due to the effect from heater 6, which becomes noise during probing and may affect probing. If the resistance value of this insulating layer is 10⁷Ω or more, the above-noted minute current is preferably reduced to such an extent that it does not affect probing.

Particularly, since circuit patterns formed on a semiconductor wafer have recently been miniaturized, the aforementioned noise should be reduced as much as possible. Thus, the resistance value of the insulating layer of 10⁷Ω or more can achieve a more reliable structure.

Furthermore, the dielectric constant of the insulating layer is preferably 10 or less. If the dielectric constant of the insulating layer exceeds 10, the electromagnetic shielding electrode layer, the guard electrode layer and chuck top 2 having the insulating layer interposed therebetween are likely to accumulate electric charges, which may cause noise.

More preferably, the dielectric constant of the insulating layer is 4 or less, and in particular, 2 or less. The reduced dielectric constant can reduce noise and also can reduce the thickness of the insulating layer required to assure the insulation resistance value or capacitance, thereby reducing thermal resistance by the insulating layer.

If chuck top 2 is formed of an insulator, between chuck top conductive layer 3 and the guard electrode layer and between chuck top conductive layer 3 and the electromagnetic shielding electrode layer, if chuck top 2 is a conductor, between chuck top 2 and the guard electrode layer and between chuck top 2 and the electromagnetic shielding electrode layer, the capacitance is preferably 5000 pF or less. If the capacitance exceeds 5000 pF, the effect of the insulating layer as a capacitor is increased, which may affect probing as noise. In particular, considering the recent miniaturization of circuit patterns formed on semiconductor wafers, the aforementioned capacitance is preferably 1000 pF or less in order to realize good probing.

As described above, the noise which may affect probing can be reduced significantly by controlling the resistance value, dielectric constant and capacitance of the insulating layer within the ranges as described above. The thickness of this insulating layer is preferably 0.2 mm or more. For the reduced size of the device and good thermal conduction from heater 6 to chuck top 2, a thinner insulating layer is better. However, the thickness of the insulating layer of less than 0.2 mm may cause a defect in the insulating layer itself or affect the durability. Furthermore, the thickness of the insulating layer is preferably 1 mm or more. The thickness of the insulating layer of 1 mm or more may mitigate the concerns about durability of the insulating layer and also improve heat conduction from heater 6.

Preferably, the thickness of the insulating layer is 10 mm or less. If the thickness of the insulating layer exceeds 10 mm, noise is blocked effectively. However, it takes much time for the heat generated in heater 6 to conduct to chuck top 2 and the semiconductor wafer placed thereon, so that it may become difficult to control the heating temperature of a semiconductor wafer. More preferably, the thickness of the insulating layer is 5 mm or less. If the thickness of the insulating layer is 5 mm or less, the temperature control may become relatively easy, although depending on the probing conditions.

Although not specifically limited, the thermal conductivity of the insulating layer is preferably 0.5 W/mK or more in order to realize good heat conduction from heater 6. If the thermal conductivity of the insulating layer is 1 W/mK or more, the heat transmission tends to become better.

Furthermore, the material of the insulating layer is not specifically limited as long as it has such heat resistance that can resist the temperature in probing and may be ceramics or resin. The resin used for the insulating layer may be, for example, silicone resin, silicone resin with a filler dispersed therein, ceramics such as alumina, or the like. The filler serves to increase heat conduction of the resin such as silicone resin used for the insulating layer. The material of the filler is not specifically limited as log as it is not reactive with the resin used for the insulating layer and may be, for example, boron nitride, aluminium nitride, alumina, or silica.

The region in which the insulating layer is formed is preferably equivalent to the region in which the electromagnetic shielding electrode layer, the guard electrode or the heater is formed. If the region in which the insulating layer is formed is small, noise may intrude from the portion that is not covered with the insulating layer.

Description will be made below with reference to an example. For example, silicone resin including boron nitride dispersed therein is used as the insulating layer. The dielectric constant of this insulating layer is 2. When the silicone resin including boron nitride dispersed therein is interposed between the electromagnetic shielding electrode layer and the guard electrode layer, between the guard electrode layer and chuck top 2, if chuck top 2 corresponds to a semiconductor wafer having a diameter of 12 inches, the insulating layer can be formed to have a diameter of 300 mm.

Here, if the thickness of the insulating layer is 0.25 mm, the capacitance can be 5000 pF. If the thickness of the insulating layer is 1.25 mm or more, the capacitance can be 1000 pF.

Since the volume resistivity of this insulating layer is 9×10¹⁵Ω·cm, the resistance value of the insulating layer can be about 1×10¹²Ω when the thickness of the insulating layer having a diameter of 300 mm is 0.8 mm or more. Furthermore, since the thermal conductivity of this insulating layer is about 5 W/mK, if the thickness of the insulating layer, which can be selected depending on the conditions of probing, is 1.25 mm or more, both the capacitance and the resistance value of the insulating layer can be adequate.

FIG. 11 shows a schematic enlarged cross sectional view of a part of the wafer holding body shown in FIG. 10. As shown in FIG. 11, a cylindrical portion 41 of support body 4 of the wafer holding body 4 in accordance with the present invention is preferably provided with a through hole 42 through which a heater electrode for supplying power to heater 6 or an electromagnetic shielding electrode layer is inserted. Here, in particular, through hole 42 is preferably formed in the vicinity of the central portion of cylindrical portion 41 of support body 4. If through hole 42 is formed close to the outer circumferential portion of cylindrical portion 41, the strength of support body 4 which is supported by circumferential portion 41 of support body 4 is reduced due to the effect of the pressure of the probe card, so that support body 4 may be deformed in proximity to through hole 42. It is noted that the illustration of the electrode and the through hole is omitted in the figures other than FIG. 11.

If the amount of warping of the wafer-placing surface (here, that surface of chuck top conducive layer 3 which is opposite to the side in contact with chuck top 2) is greater than 30 μm, the probe pin of a probe card is in improper contact during probing, so that the electric characteristics of a semiconductor wafer cannot be evaluated or a failure determination is made due to poor contact. Undesirably, semiconductor chips are thus evaluated unduly poorly, thereby possibly reducing yields.

It is not preferable that the parallelism between the wafer-placing surface and the bottom surface of support body 4 is greater than 30 μm, because poor contact may take place similarly. Even if the amount of warping of the wafer-placing surface and the parallelism between the wafer-placing surface and the bottom surface of support body 4 is as good as 30 μm or less at room temperature, it is not preferable if the amount of warping of the wafer-placing surface and the parallelism of the wafer-placing surface is greater than 30 μm during probing of a semiconductor wafer heated at 200° C. The same applies to probing of a semiconductor wafer at −70° C. In other words, it is preferable that both of the amount of warping of the wafer-placing surface and the parallelism between the wafer-placing surface and the bottom surface of support body 4 is 30 μm or less throughout the temperature range for probing (for example, −70° C. to 200° C.)

Chuck top conductive layer 3 is formed on the surface of chuck top 2. Chuck top conductive layer 3 is formed to serve to protect chuck top 2 from corrosive gas, acid or alkaline chemicals, organic solvent or water that are usually used in manufacturing a semiconductor chip and to serve to establish a ground between chuck top conductive layer 3 and a semiconductor wafer placed on chuck top 2 in order to block noise from below chuck top 2.

The method of chuck top conductive layer 3 is not specifically limited and may include applying a conductive paste by screen printing followed by baking, vapor deposition or sputtering, thermal spraying or plating, or the like.

Among others, thermal spraying or plating is preferably used to form chuck top conductive layer 3. Such a method does not involve a heat treatment in forming chuck top conductive layer 3 and thus does not cause warp in chuck top 2, which would be caused by heat treatment. In addition, because of relatively low costs, chuck top conductive layer 3 can be formed inexpensively with excellent characteristics.

In particular, chuck top conductive layer 3 is preferably fabricated by forming a thermal sprayed film on chuck top 2 by thermal spraying and forming a plating film on the thermal sprayed film by plating. The thermal sprayed film formed by thermal spraying is superior to a plating film formed by plating in adhesiveness of ceramics or a metal-ceramics composite. This is because the sprayed material, for example, aluminium, nickel or the like produces some amount of oxide, nitride or oxynitride during thermal spraying, and the produced compound reacts with the surface of chuck top 2 and strongly adheres thereto.

However, since the sprayed film includes these compounds, the conductivity of the thermal sprayed film becomes low. By contrast, the plating film can form almost pure metal, so that chuck top conductive layer 3 with excellent conductivity can be formed although the adhesive strength with chuck top 2 is not so high as a thermal sprayed film. Therefore, when a thermal sprayed film is underlaid and a plating film is formed thereon, the plating film has good adhesive strength with the thermal sprayed film, which is a metal, and also provides good electric conductivity.

Preferably, surface roughness Ra of chuck top conductive layer 3 on chuck top 2 is 0.5 μm or less. If surface roughness Ra exceeds 0.5 μm, in determination of the electric characteristics of a semiconductor wafer generating a large amount of heat, the heat generated by self-heating of the semiconductor wafer itself cannot be dissipated from chuck top 2 during probing, thereby increasing the temperature of the semiconductor wafer and possibly resulting in thermal breakdown. It is noted that surface roughness Ra of chuck top conductive layer 3 of 0.02 μm or less is preferable in that heat can be dissipated more efficiently.

When the heating element installed at chuck top 2 is heated to probe a semiconductor wafer, for example, at 200° C., the temperature of the bottom surface of support body 4 is preferably 100° C. or lower. If the temperature of the bottom surface of support body 4 exceeds 100° C., the driving system below support body 4 is distorted due to the thermal expansion coefficient difference and is thus degraded in precision, thereby causing inconvenience such as misalignment in probing, warping of a semiconductor wafer, or improper contact of a probe pin due to the reduced parallelism. Accordingly, accurate inspection of a semiconductor wafer cannot be achieved. In addition, when the characteristics of a semiconductor wafer are determined with the temperature thereof increased to 200° C., followed by determination at room temperature, it takes much time to cool the semiconductor wafer from 200° C. to room temperature, thereby degrading throughput.

Preferably, Young's modulus of chuck top 2 is 250 GPa or more. If Young's modulus of chuck top 2 is less than 250 GPa, the load applied to chuck top 2 during probing causes bending of chuck top 2, thereby significantly deteriorating the flatness and parallelism of the wafer-placing surface. Therefore, in view of the forgoing situations, Young's modulus of chuck top 2 is preferably 250 GPa or more, more preferably 300 GPa or more.

Preferably, the thermal conductivity of chuck top 2 is 15 W/mK or more. If the thermal conductivity of chuck top 2 is less than 15 W/mK, the uniformity of temperature distribution of a semiconductor wafer placed on chuck top 2 may become worse. Therefore, if the thermal conductivity of chuck top 2 is 15 W/mK or more, such thermal uniformity can be obtained that is acceptable to probing. The material of chuck top 2 having such thermal conductivity may include, for example, alumina at a purity of 99.5% (thermal conductivity 30 W/mK).

Preferably, the thermal conductivity of chuck top 2 is 170 W/mK or more. The material of chuck top 2 having such thermal conductivity may include, for example, aluminium nitride (170 W/mK), a composite of silicon and silicon carbide (170 W/mK to 220 W/mK), or the like. If the thermal conductivity of chuck top 2 is 170 W/mK or more, chuck top 2 can be excellent in thermal uniformity.

Preferably, the thickness of chuck top 2 is 5 mm or more. If the thickness of chuck top 2 is less than 5 mm, the load applied to chuck top 2 during probing causes bending of chuck top 2, thereby significantly deteriorating the flatness and parallelism of the wafer-placing surface. Thus, because of the poor contact of the probe pin, the electric characteristics of a semiconductor wafer may not be determined accurately and in addition, a semiconductor wafer may be broken. In view of the forgoing situations, the thickness of chuck top 2 is preferably 5 mm or more, more preferably 7 mm or more.

As a material of chuck top 2, for example, a metal-ceramics composite, ceramics or metal can be used. Here, preferably used as a metal-ceramics composite is a composite of aluminium and silicon carbide, a composite of silicon and silicon carbide or a composite of aluminium, silicon and silicon carbide, which have relatively high thermal conductivity and provide thermal uniformity when a semiconductor wafer is heated. In particular, a composite of silicon and silicon carbide has especially high Young's modulus and has high thermal conductivity, so that it is particularly preferable to use a composite of silicon and silicon carbide as a material of chuck top 2.

Furthermore, since these composites are conductive, the heating element can be formed, for example, by forming an insulating layer on the surface opposite to the wafer-placing surface of chuck top 2 by thermal spraying or screen printing and screen-printing a conductive layer on the insulating layer or forming a conductive layer in a prescribed pattern by vapor deposition or the like.

Alternatively, the heating element can also be formed by forming a metal foil made of stainless steel, nickel, silver, molybdenum, tungsten, chrome, or an alloy thereof in a prescribed heating element pattern by etching. In this method, the heating element can be insulated from chuck top 2 by forming an insulating layer as described above. Alternatively, for example, an insulative sheet may be inserted between chuck top 2 and the heating element. In this case, preferably, an insulating layer can be formed remarkably cheaply and easily as compared with the above-noted method. The insulative sheet for use in this case includes a mica sheet or a resin sheet such as epoxy resin, polyimide resin, phenol resin or silicone resin in view of heat resistance. Among those, especially a mica sheet is preferably used. The reason is that a mica sheet is excellent in heat resistance and electric insulation, is easily processed, and moreover cheap.

Ceramics as a material of chuck top 2 is relatively usable since it does not require formation of an insulating layer as described above. In this case, the method of forming a heating element can be selected from the methods as described above. Among the materials of ceramics used as a material of chuck top 2, alumina, aluminium nitride, silicon nitride, mullite, or an alumina and mullite composite is preferable. These materials are particularly preferable since they have relatively high Young's modulus, thereby reducing deformation of chuck top 2 caused by pressing by a probe card.

Among them, alumina is most excellent as a material of chuck top 2 because of relatively low costs and excellent electric characteristics at high temperature. In view of increasing insulation property at high temperature, the purity of alumina is preferably 99.6% or more, more preferably 99.9% or more. More specifically, silicon oxides, alkaline-earth metal oxides, or the like is added to alumina in order to reduce the sintering temperature during sintering. This reduces the electric characteristics of pure alumina, such as electrical insulation at high temperature. Therefore, the purity of alumina is preferably 99.6% or more, more preferably 99.9% or more.

Alternatively, a metal may also be used as a material of chuck top 2. The metal used as a material of chuck top 2 includes, tungsten, molybdenum, or an alloy thereof, which have high Young's modulus. Specifically, the alloy includes, for example, a tungsten and copper alloy or a molybdenum and copper alloy. These alloys can be fabricated by impregnating copper in tungsten or molybdenum. Since these alloys are conductors similar to the aforementioned ceramics-metal composite, the method as described above is applicable as it is to form chuck top conductive layer 3 and a heating element.

The amount of warping of the wafer-placing surface is preferably 30 μm or less when a load of 3.1 MPa is applied to the surface of the wafer-placing surface. In probing, a number of probe pins for inspecting the electric characteristics of a semiconductor wafer are pressed against a semiconductor wafer from a probe card, so that that pressure may affect chuck top conductive layer 3 causing some warping of the wafer-placing surface. Here, if the amount of warping of the wafer-placing surface exceeds 30 μm, the probe pin of the probe card cannot be pressed against the semiconductor wafer uniformly, so that it may become impossible to inspect the electric characteristics of the semiconductor wafer. More preferably, the amount of warping of the wafer-placing surface is 10 μm or less when a load of 3.1 MPa is applied to the surface of chuck top conductive layer 3.

The wafer holding body in accordance with the present invention is suitably used for a heater unit for a wafer prober for heating a processed target such as a semiconductor wafer, a wafer-heating heater unit, and a semiconductor heating device including the wafer-heating heater unit, or a wafer prober for inspecting a processed target such as a semiconductor wafer.

Wafer holding body 1 in accordance with the present invention is suitably applied to a wafer prober, handler device or tester device to take advantage of the characteristics of wafer holding body 1 in accordance with the present invention, which has high heat resistance and thermal conductivity.

(Experiment 1)

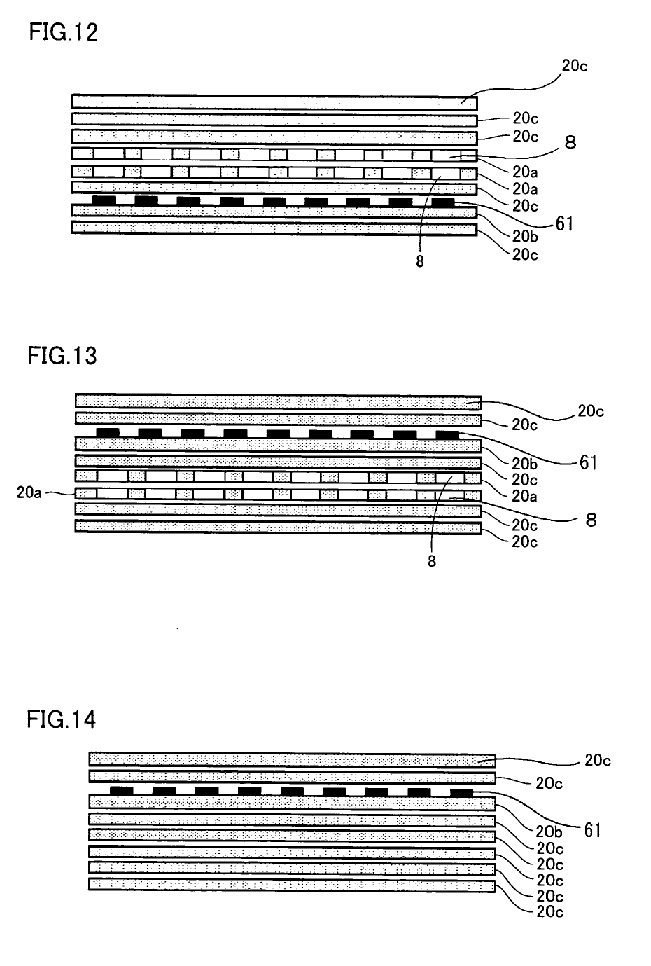

A green sheet made of aluminum nitride containing 0.5% by mass of yttrium on the oxide basis was prepared. As shown in FIG. 12, a green sheet 20a from which a portion corresponding to channel 8 was removed, a green sheet 20b having a tungsten paste printed thereon as heating element 61, and an unprocessed green sheet 20c were stacked to form a molded body, which was baked in the nitrogen atmosphere at 1850° C.

The upper and lower surfaces of a chuck top resulting from baking the molded body were polished. Then, a concentrically arranged groove and a through hole were formed in the chuck top for vacuum chucking of a semiconductor wafer. Then, the upper surface (the surface on the wafer-placing surface side) of the chuck top was provided with nickel plating to form a chuck top conductive layer. Thereafter, the chuck top conductive layer was polished such that the amount of warping of the surface of the chuck top conductive layer was 10 μm and surface roughness Ra of the surface of the chuck top conductive layer was 0.02 μm. The chuck top having the chuck top conductive layer formed thereon had a diameter of 310 mm and a thickness of 10 mm.

Furthermore, as shown in FIG. 13, a chuck top of the same size as described above having a similar chuck top conductive layer as described above was fabricated in a similar manner as described above by stacking and thereafter baking the green sheets except that the position of the heating element was changed. In addition, as shown in FIG. 14, a chuck top of the same size as described above having a similar chuck top conductive layer as described above was fabricated in a similar manner as described above by stacking and thereafter baking the green sheets except that a channel was not formed.

Then, a cylinder-like, mullite-alumina composite having a diameter of 310 mm and a thickness of 40 mm was prepared as a support body. Spot facing with an inner diameter of 295 mm and a depth of 20 mm was performed on this support body, so that a cavity was formed inside the support body. In addition, a through hole was formed in the support body to connect an electrode for supplying power to the heating element.

Subsequently, three kinds of chuck tops as described above were each joined on the above-noted support body, resulting in three kinds of wafer holding bodies for a wafer prober.

Here, the wafer holding body for a wafer prober formed by stacking green sheets as shown in FIG. 12 and the wafer holding body for a wafer prober formed by stacking green sheets as shown in FIG. 13 have the respective heating elements on opposite sides of the wafer-placing surface.

As shown in FIG. 12, in the wafer holding body for a wafer prober formed by stacking green sheets, the heating element is provided on the wafer-placing surface side as viewed from the channel. On the other hand, as shown in FIG. 13, in the wafer holding body for a wafer prober formed by stacking green sheets, the heating element is provided on the side opposite to the wafer-placing surface side as viewed from the channel.

For those two kinds of wafer holding bodies for a wafer prober which have channels, of the above-noted three kinds of wafer holding bodies for a wafer prober, Galden at −70° C. was fed into their channels, and the cooling time was measured for the temperature indicated by a wafer thermometer installed at the wafer-placing surface of the wafer holding body for a wafer prober to fall from room temperature to −55° C.

On the other hand, for the remaining one kind of wafer holding body for a wafer prober which has no channel, the air cooled at −70° C. was blown from the base portion of the support body, and the cooling time was measured for the temperature indicated by a wafer thermometer installed at the wafer-placing surface of the wafer holding body for a wafer prober to fall from room temperature to −55° C.

For the wafer holding body for a wafer prober formed by stacking green sheets as shown in FIG. 12, the cooling time from room temperature to −55° C. was 25 minutes. For the wafer holding body for a wafer prober formed by stacking green sheets as shown in FIG. 13, the cooling time from room temperature to −55° C. was 27 minutes. For the wafer holding body for a wafer prober formed by stacking green sheets as shown in FIG. 14, the temperature did not reach −55° C. even after cooling for one hour.

(Experiment 2)

Three kinds of wafer holding bodies for a wafer prober similar to Experiment 1 were fabricated except that the material of the chuck top was 99.5% pure alumina, and the cooling time from room temperature to −55° C. was measured similarly to Experiment 1.

As a result, for the wafer holding body for a wafer prober formed by stacking green sheets as shown in FIG. 12, the cooling time from room temperature to −55° C. was 32 minutes. For the wafer holding body for a wafer prober formed by stacking green sheets as shown in FIG. 13, the cooling time from room temperature to −55° C. was 34 minutes. For the wafer holding body for a wafer prober formed by stacking green sheets as shown in FIG. 14, the temperature did not reach −55° C. even after cooling for one hour.

(Experiment 3)

A plurality of disc-like substrates of a composite of Si and SiC (Si-SiC composite) each having a diameter of 310 mm and a thickness of 5 mm were prepared. Each substrate was partially removed in striped patterns by machining in order to form channels. Then, a plurality of stripe-like concave portions were formed in each substrate. Then, nickel plating was applied on the entire surface of each substrate having the concave portions formed therein.

Then, two substrates were set such that their concave portions faced each other, and then joined to each other using silver solder, resulting in a chuck top having channels formed therein.

Subsequently, nickel plating was applied on the surface on the wafer-placing surface side of the chuck top to form a chuck top conductive layer.

Thereafter, the chuck top conductive layer was polished and finished such that the amount of warping of the surface of the chuck top conductive layer was 10 μm and surface roughness Ra of the surface of the chuck top conductive layer was 0.02 μM. The chuck top having the chuck top conductive layer formed thereon had a diameter of 310 mm and a thickness of 10 mm.

In addition, a stainless steel foil was etched to serve as a heating element, and a heater having the etched stainless steel foil sandwiched between silicone resins was attached to the surface opposite to the wafer-placing surface side of the chuck top.

Then, the chuck top fabricated in the forgoing manner was joined on a support body having a similar shape and size as in Experiment 1, resulting in a wafer holding body for a wafer prober.

The above-noted wafer holding body for a wafer prober was cooled similarly to Experiment 1, and the cooling time from room temperature to −55° C. was measured similarly to Experiment 1. As a result, for this wafer holding body for a wafer prober, the cooling time from room temperature to −55° C. was 24 minutes.

(Experiment 4)

A chuck top of 8 mm thick not having a channel and having a heating element was fabricated as shown in FIG. 14 by stacking and thereafter baking green sheets made of aluminium nitride similarly to Experiment 1.

Then, in order to form channels on the surface opposite to the wafer-placing surface side of the above-noted chuck top, the chuck top was partially removed in striped patterns by machining. Thus, a plurality of stripe-like concave portions were formed in the chuck top.

Then, a disc-like coating member made of aluminium nitride was prepared which had a diameter of 3 mm and were of the same material with the above-noted chuck top. In addition, mixed powder of AlN—Al₂O₃—Y₂O₃ at a ratio of 20:50:30 by mass was made into a paste with an organic solvent and then coated on the joining surface of the coating member.

Then, the above-noted chuck top and the above-noted coating member were held in a nitrogen atmosphere at 1800° C. in abutment with each other, whereby the chuck top and the coating member were joined with each other.

Then, the upper and lower surfaces of the joined body of the chuck top and the coating member were polished, and a concentrically-arranged groove and a through hole were formed in this joined body for vacuum chucking or a semiconductor wafer. In addition, a nickel plating was applied on that surface of the chuck top that was not joined with the coating member to form a chuck top conductive layer.

Thereafter, the chuck top conductive layer was polished and finished such that the amount of warping of the surface of the chuck top conductive layer was 10 μm and surface roughness Ra of the surface of the chuck top conductive layer was 0.02 μm. The chuck top having the chuck top conductive layer formed thereon had a diameter of 310 mm and a thickness of 10 mm.

Then, the chuck top fabricated in the forgoing manner was mounted on a support body having a similar shape and size as in Experiment 1, resulting in a wafer holding body for a wafer prober.

The above-noted wafer holding body for a wafer prober was cooled similarly to Experiment 1, and the cooling time from room temperature to −55° C. was measured similarly to Experiment 1. As a result, for this wafer holding body for a wafer prober, the cooling time from room temperature to −55° C. was 27 minutes.

Furthermore, a wafer holding body for a wafer prober was fabricated in a similar manner as described above except that machining for forming a channel was performed not on the chuck top but on the joining surface of the coating member. Then, this wafer holding body for a wafer prober was cooled similarly to Experiment 1, and the cooling time from room temperature to −55° C. was measured similarly to Experiment 1. As a result, the cooling time was 28 minutes.

In addition, a wafer holding body for a wafer prober was fabricated in a similar manner as described above except that the material of the chuck top and the coating member was replaced with alumina or Si—SiC composite. Then, the cooling time was measured similarly to Experiment 1. It is noted that when alumina was used as a material of the chuck top and the coating member, the chuck top and the coating member were joined with each other using an active metal solder.

As a result, when alumina was used as a material of the chuck top and the coating member, the above-noted cooling time was 35 minutes for the one having a channel formed in the chuck top by machining, while the cooling time was 36 minutes for the one having a channel formed in the coating member by machining.

On the other hand, when Si—SiC composite was used as a material of the chuck top and the coating member, the above-noted cooling time was 26 minutes for the one having a channel formed in the chuck top by machining, while the cooling time was 27 minutes for the one having a channel formed in the coating member by machining.

Furthermore, for the one having a channel formed in the coating member by machining and using aluminium nitride as a material of the chuck top and Si—SiC composite as a material of the coating member, the above-noted cooling time was 27 minutes.

(Experiment 5)

Similarly to Experiment 1, disc-like chuck tops each having a diameter of 310 mm and a thickness of 10 mm were fabricated, each of which had a heating element and did not have a channel, by stacking and thereafter baking green sheets made of such chuck top materials as shown in Table 1 as shown in FIG. 14. It is noted that when the material of the chuck top was Si—SiC composite, the chuck top was fabricated by inserting a heating element sandwiched between silicone resins between two Si—SiC composite substrates of 5 mm thick each.

Then, a copper pipe shaped like a quadrangle in cross section was attached to the surface opposite to the wafer-placing surface side of each of these chuck tops by a stainless steel band. At that time, an interposing layer of silicone resin having a diameter of 0.2 mm with boron nitride dispersed therein was inserted between the copper pipe and the chuck top. In addition, spot facing was performed on that surface of the chuck top which was provided with the stainless steel band, and the above-noted copper pipe was attached to the spot-faced portion with the above-noted interposing layer inserted therebetween.

Then, each of the chuck tops fabricated as described above was joined on a support body having a similar shape and size as in Experiment 1, resulting in a wafer holding body for a wafer prober. Then, Galden of −70° C. was fed through the copper pipe, and similarly to Experiment 1, the cooling time was measured for the temperature indicated by a wafer thermometer installed at the wafer-placing surface of the wafer holding body for a wafer prober to fall from room temperature to −55° C. The results are shown in Table 1.

TABLE 1

| | | | cooling time |
|---|---|---|---|
| chuck top material | interposing layer | spot facing | (min) |
| alumina | non-inserted | non-performed | 45 |
| alumina | inserted | non-performed | 41 |
| alumina | inserted | performed | 39 |
| aluminium nitride | non-inserted | non-performed | 40 |
| aluminium nitride | inserted | non-performed | 36 |
| aluminium nitride | inserted | performed | 34 |
| Si—SiC composite | non-inserted | non-performed | 41 |
| Si—SiC composite | inserted | non-performed | 37 |
| Si—SiC composite | inserted | performed | 34 |

As shown in Table 1, when an interposing layer is inserted or when spot facing is performed on the chuck top, the cooling time is reduced.

(Experiment 6)

A green sheet of aluminium nitride containing 0.5% by mass of yttrium on the oxide basis was prepared. As shown in FIG. 12, green sheet 20a from which a portion corresponding to channel 8 was removed, green sheet 20b having a tungsten paste printed thereon as heating element 61, and unprocessed green sheet 20c were stacked to form a molded body, which was baked in a nitrogen atmosphere at 1850° C.

The upper and lower surfaces of a chuck top resulting from the baking were polished. Then, spot-faced holes each having a diameter of 1.1 mm and a depth of 0.9 mm were formed at 10 places on the upper surface of the chuck top, and an alumina ball of a diameter of 1 mm was inserted in each of the spot-faced holes, resulting in a wafer holding body. The wafer holding body fabricated in this manner had a diameter of 310 mm and a thickness of 10 mm.

Furthermore, a wafer holding body of the same size as described above was fabricated in a similar manner as described above except that the position of the heating element was changed by stacking and thereafter baking the green sheets as shown in FIG. 13. In addition, a wafer holding body of the same size as described above was fabricated in a similar manner as described above except that the a channel was not formed by stacking and thereafter baking the green sheets as shown in FIG. 14.

Then, a wafer thermometer including a temperature-measurement resistance body was installed at the wafer-placing surface of each of the above-noted three kinds of wafer holding bodies. Then, for those two kinds of wafer holding bodies which have a channel, of the above-noted three kinds of wafer holding bodies, water of 25° C. was fed through the channel, and the cooling time was measured for the temperature indicated by the wafer thermometer installed at the wafer-placing surface of the wafer holding body to fall from 180° C. to 70° C. On the other hand, for the remaining one kind of wafer holding body having no channel, the wafer thermometer was left to measure the cooling time for the temperature indicated by the wafer thermometer to fall from 180° C. to 70° C.

As a result, for the wafer holding body formed by stacking green sheets as shown in FIG. 12, it took 3.5 minutes to be cooled to 70° C. For the wafer holding body formed by stacking green sheets as shown in FIG. 13, it took 4 minutes to be cooled to 70° C. For the wafer holding body formed by stacking green sheets as shown in FIG. 14, the temperature did not reach 70° C. even after cooling for 20 minutes.

(Experiment 7)

A green sheet of aluminium nitride containing 0.5% by mass of yttrium on the oxide basis was prepared. As shown in FIG. 12, green sheet 20a from which a portion corresponding to channel 8 was removed, green sheet 20b having a tungsten paste printed thereon as a heating element 61, and unprocessed green sheet 20c were stacked to form a molded body, which was baked in a nitrogen atmosphere at 1850° C., resulting in a chuck top.

Furthermore, a chuck top of the same size as described above was fabricated in a similar manner as described above except that the position of the heating element was changed by stacking and thereafter baking the green sheets as shown in FIG. 13. In addition, a chuck top of the same size as described above was fabricated in a similar manner as described above except that a channel was not formed by stacking and thereafter baking the green sheets as shown in FIG. 14.

Each of the chuck tops fabricated in this manner was shaped like a disc having a diameter of 320 mm and a thickness of 11 mm.

The upper and lower surfaces of each resulting chuck top were polished and finished such that the amount of warping of the wafer-placing surface of the chuck top was 10 μm and surface roughness Ra of the surface of each chuck top was 0.02 μm.

Then, spot-faced holes each having a diameter of 1.2 mm and a depth of 0.9 mm were formed at 10 places on the upper surface of each chuck top, and an alumina ball of a diameter of 1 mm was inserted in each of the spot-faced holes, resulting in a wafer holding body.

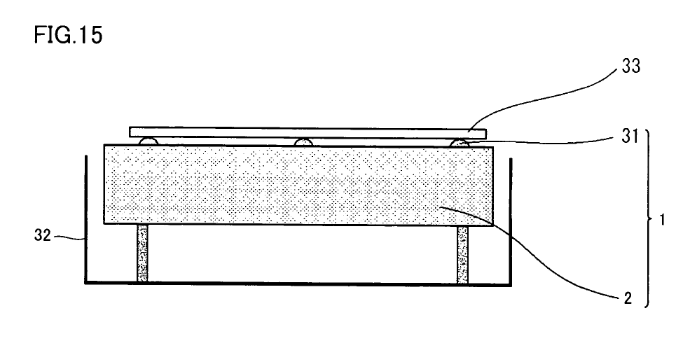

Then, as shown in FIG. 15, each wafer holding body 1 fabricated as described above was installed in a container 32 made of stainless steel, resulting in a wafer-heating heater unit to be used in heating a resist or the like.

A wafer thermometer 33 of a diameter of 12 inches was installed on a ball 31 made of alumina of each wafer-heating heater unit which was heated to 180° C. by supplying power to the heating element. After two minutes, power supply to the heating element was stopped, and then Fluorinert was fed through the channel of wafer holding body 1 for cooling down to 70° C.

For the wafer-heating heater unit using the wafer holding body formed by stacking the green sheets as shown in FIG. 12, the above-noted cooling time was 5 minutes. For the wafer-heating heater unit using the wafer holding body formed by stacking the green sheets as shown in FIG. 13, the above-noted cooling time was 6 minutes. For the wafer-heating heater unit using the wafer holding body formed by stacking the green sheets as shown in FIG. 14, the temperature did not reach 70° C. even after being left for 30 minutes.

In accordance with the present invention, a wafer holding body excellent in cooling speed can be obtained by forming a channel in a wafer holding body. With improved cooling speed of a semiconductor wafer, throughput may be improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A wafer holding body for placing a semiconductor wafer, comprising a channel formed in said wafer holding body.

2. The wafer holding body according to claim 1, further comprising a coating member attached to a side opposite to a wafer-placing surface of said wafer holding body, wherein said channel is formed between said wafer-placing surface and said coating member.

3. The wafer holding body according to claim 1, further comprising a coating member attached to a side opposite to a wafer-placing surface of said wafer holding body, wherein a part of said channel is formed of a concave portion formed in a main body portion of said wafer holding body.

4. The wafer holding body according to claim 1, further comprising a coating member attached to a side opposite to a wafer-placing surface of said wafer holding body, wherein a part of said channel is formed of a concave portion formed in said coating member.

5. The wafer holding body according to claim 1, further comprising a tubular member attached to a side opposite to a wafer-placing surface of said wafer holding body, wherein said channel is a hollow portion of said tubular member.

6. The wafer holding body according to claim 1, wherein said wafer holding body has a heating element on a side opposite to a wafer-placing surface of said wafer holding body.

7. The wafer holding body according to claim 6, wherein said heating element is provided on a wafer-placing face side of said wafer holding body as viewed from said channel.

8. The wafer holding body according to claim 6, wherein said heating element is provided on a side opposite to a side at which the wafer-placing surface of said wafer holding body exists, as viewed from said channel.

9. The wafer holding body according to claim 6, further comprising a coating member attached to a side opposite to the wafer-placing surface of said wafer holding body, wherein said heating element is provided on a surface of said coating member.

10. A method of manufacturing a wafer holding body having a channel formed in a main body portion of the wafer holding body, comprising the steps of: embedding a core in a molded body before baking of the main body portion of the wafer holding body; and baking the molded body having said core embedded therein to cause said core to disappear thereby forming a channel.

11. A method of manufacturing a wafer holding body having a coating member attached to a side opposite to a wafer-placing surface of the wafer holding body and having a channel formed therein, wherein the channel is formed in the wafer holding body by joining a main body portion of the wafer holding body and the coating member with each other.

12. The method of manufacturing a wafer holding body according to claim 11, wherein said main body portion of the wafer holding body and said coating member are joined with each other by a solder material, a joining material containing an inorganic material, or a mechanical method.

13. The method of manufacturing a wafer holding body according to claim 12, wherein said mechanical method is screwing.

14. A method of manufacturing a wafer holding body having a coating member attached to a side opposite to a wafer-placing surface of the wafer holding body and having a channel formed therein, wherein the channel is formed by joining a main body portion of the wafer holding body and a tubular member with each other.

15. The method of manufacturing a wafer holding body according to claim 14, wherein said main body portion of the wafer holding body and said tubular member are joined with each other by a solder material, a joining material containing an inorganic material, or a mechanical method.

16. The method of manufacturing a wafer holding body according to claim 15, wherein said mechanical method is screwing.

17. A heater unit for a wafer prober, comprising the wafer holding body according to claim 1.

18. A wafer prober comprising the heater unit for a wafer prober according to claim 17.

19. A wafer-heating heater unit comprising the wafer holding body according to claim 1.

20. A semiconductor heating device comprising the wafer-heating heater unit according to claim 19.
